(19) United States
(12) Patent Application Publication
(10) Pub. No.: US 2011/0225457 A1
(43) Pub. Date: Sep. 15, 2011

(54) System for Testing a Multitasking Computation Architecture Based on Communication Data between Processors and Corresponding Test Method

(75) Inventor: Iker De Poy Alonso, Saint Martin d'Heres (FR)

(73) Assignee: STMicroelectronics (Crolles 2) SAS, Crolles (FR)

(21) Appl. No.: 13/036,836

(22) Filed: Feb. 28, 2011

(30) Foreign Application Priority Data
Mar. 11, 2010 (FR) 1051762

(51) Int. Cl. G06F 11/263

(52) U.S. Cl. 714/35; 714/E11.177

(57) ABSTRACT

System for testing a multitasking computation architecture, comprising a set of processors linked by data communication channels, comprising a generating stage for generating sequences of test instructions based on characteristics of said processors comprising programming rules for the computation processors, characterized in that it comprises a control stage for the stage for generating sequences based on data representative of the data communication channels.

### CROSS-REFERENCE TO RELATED APPLICATION

This application claims the priority benefit of French patent application number 1051762, filed Mar. 11, 2010, entitled “System for testing a multitasking computation architecture based on communication data between processors and corresponding test method,” which is hereby incorporated by reference to the maximum extent allowable by law.

### TECHNICAL FIELD

The invention relates, generally, to multitasking computation architectures and, in particular, to a system and a method for testing such architectures.

### BACKGROUND

Multitasking computation architectures include architectures capable of alternately carrying out a number of instructions. For example, multitasking computation architectures include any type of multitasking architectures, such as the architectures that use the VLIW (Very Long Instruction Word) technology, according to which each word is likely to include a number of instructions, the architectures generally known as “multithreading architectures,” according to which a computer is capable of alternately processing a number of instruction files, the SIMD (Single Instruction On Multiple Data) architectures, according to which a computer comprises a number of computation units operating in parallel, the floating-point architectures, and so on.

In order to test such multitasking computation architectures, it is generally desirable to perform a number of test instructions by using simulation techniques.

First of all, tests are generally carried out on an instructions set simulator, or ISS, then on register transfers and then on a summarized final version of the processor as implemented on a programmable logic circuit.

Such tests are intended to identify different failure levels that are likely to occur within the architecture. They are also intended to identify failures within the compiler, in particular with regard to the instructions, the syntax, the semantics, etc.

The tests are also capable of covering a maximum, or even all, of the multitasking scenarios likely to be implemented within the architectures.

There are already, in the state of the art, devices for testing computation architectures. The company OBSIDIAN proposes, in this respect, a test tool marketed under the name Raven®. This tool is capable of taking into account the multitasking character of an architecture to be tested. However, it is totally unsuitable for taking into account the communication environment in a multiprocessor system.

Reference can also be made to the test tool called Genesys®, marketed by the company IBM, which offers a dynamic and configurable test generation tool.

Generally, it has been found that the test tools that are currently available can be used only by specialists in multitasking processing architectures, and are lengthy and tedious to use. And finally, they are relatively costly.

There is therefore proposed, according to the present description, a system and a method for testing a multitasking computation architecture that is less complex to use and is capable of taking into account the environment in which the processors of the architecture are arranged.

### SUMMARY

In an embodiment, a system for testing a multitasking computation architecture, which includes a plurality of processors linked by data communications channels, is provided. The system comprises a generating stage and a control stage. The generating stage generates sequences of test instructions based on characteristics of a plurality of processors, wherein the characteristics comprise programming rules for the plurality of processors. The control stage provides to the generating stage data representative of the data communication channels.

In another embodiment, a method for testing a multitasking computation architecture is provided, wherein the multitasking computation architecture comprises a plurality of processors linked by data communications channels. The method includes generating sequences of test instructions based on characteristics of the plurality of processors, the characteristics comprising programming rules for the plurality of processors. The sequences of test instructions are based at least in part on data representative of the communications channels.

In yet another embodiment, a computer program product for testing a multitasking computation architecture is provided. The computer program product comprises computer program code for generating test programs for a plurality of processors interconnected by one or more data communication channels, and computer program code for controlling the generating test programs and to control the testing of the plurality of processors.

### BRIEF DESCRIPTION OF THE DRAWINGS

Other aims, features and advantages of embodiments will become apparent from reading the following description, given solely as a nonlimiting example, and with reference to the appended drawings, in which:

FIG. 1 illustrates the general architecture of a system for testing a multitasking computation architecture according to the first aspect mentioned hereinabove;

FIG. 2 is a flow diagram illustrating the main phases of the algorithm implemented within the control stage; and

FIGS. 4 and 5 illustrate how the architecture of the communication channels linking the processing processors is taken into account.

### DETAILED DESCRIPTION OF ILLUSTRATIVE EMBODIMENTS

According to an aspect, a system is proposed for testing a multitasking computation architecture having a set of processors linked by data communication channels, wherein the system comprises a stage for generating sequences of test instructions based on characteristics of said processors based on programming rules for the processors.

In one embodiment, this system comprises a control stage for the stage for generating sequences based on data representative of the data communication channels.

According to another feature, the control stage is invoked once for each test of an architecture and invokes the generating stage for generating sequences of instructions for each test of a processor.

This test system may also comprise a data generator in the communication channels.

It may also comprise a memory for storing a description of the programming instructions for the computation architecture.

According to yet another feature, it may comprise a memory for storing a description of the architecture to be tested.

There is also proposed, according to another aspect, a method for testing a multitasking computation architecture having a set of processors linked by data communication channels, wherein the method comprises generating of sequences of test instructions based on the characteristics, including programming rules, of said processors.

In one embodiment, according to this method, the sequences of test instructions are generated from data representative of the communication channels.

According to another embodiment, the data representative of the communication channels is collected from the data circulating between the processors.

For the test of a first receiving processor, the data circulating towards said processor may be generated randomly.

An identifier can also be assigned to each processor. The processors may be tested sequentially based on the identifiers assigned to the processors.

Advantageously, the sequences of test instructions may be generated randomly from operations and operands selected from test constraints generated randomly or specified by a user.

There is also proposed, according to another aspect, a multitasking computation architecture comprising a test system as defined hereinabove.

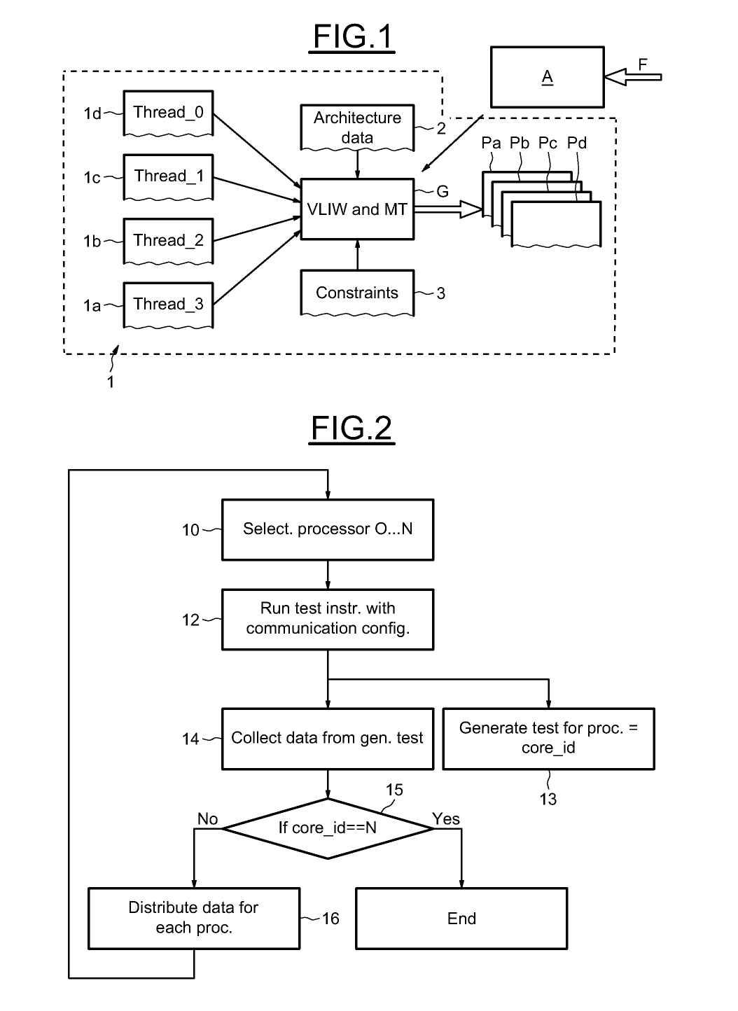

The general architecture of a test system for testing a multitasking computation architecture, which may also be referred to as a multi-thread architecture, will be described first with reference to FIG. 1.

The test system is intended to generate, randomly, an indeterminate number of test sequences Pa, Pb, Pc, Pd modulo n, n being the number of computation threads of a multi-thread architecture. The aim here is to generate a sequence of test instructions for each thread of the multi-thread architecture, the set of these n sequences constituting a multi-thread test. In other words, the aim is therefore to create a set of test sequences for testing all the tasks executed by a multitasking architecture.

The test system that can be seen in FIG. 1 may also control the procedure for generating test sequences by taking into account the communication architecture between the processors by implementing a communication between the processors so as to collect data when generating tests for the various processors to send to the other processors.

As illustrated in FIG. 1, the test system may comprise a first control stage A and a second generating stage B for generating test instructions controlled by the first control stage A.

For each test of a multitasking computation architecture, the first control stage A is invoked once, whereas the second generating stage B, handling the generation of the test sequences, is invoked for each processor and therefore a number of times equal to the number of processors in the computation architecture.

It will be noted that the test system illustrated in FIG. 1 allows a user, for example a circuit designer, a quality controller, etc., to perform tests that are directly selected or, on the other hand, randomly selected. However, the tests implemented are founded on the execution of test programs generated according to the programming rules for the computation architecture, according to the architecture of the computer or processor to be checked, and/or according to the characteristics of the communication channels between the processors.

When a user carries out a non-random test, the user selects the type and the format of the instructions and the operands of the test sequences. On the other hand, when the tests are performed randomly, one or more of these values are chosen randomly by the test system.

As FIG. 1 shows, the second generating stage B for generating instructions comprises test sequence generators 1a-1b, collectively referred to as sequence generators 1, for generating sequences of test instructions and for storing test sequences Thread 0, . . . , Thread 3, each corresponding to a test scenario, wherein each test sequence may include text files using parameterizable macroprograms. These files may be stored in a test system memory. Each scenario makes it possible to provide a large number of tests generated randomly relative to scenario constraints.

This second generating stage B also includes architecture data 2 that includes a representation of the computation architecture to be tested and parameters descriptive of the program instructions for the computation architecture to be tested. The second generating stage B further includes a test program generator G that generates test programs according to the programming rules for the architecture to be tested. The architecture data 2 may be stored in one or more memories.

Constraints 3, which may be stored in one or more memories, relate to the generation of the test sequences. For example, constraints 3 may include directives likely to influence the values of the operation codes and the operands. Generally, the higher the constraints, the more selective the tests.

The first control stage A receives, as input, a configuration file F introduced, e.g., directly by the user in a configuration file, this file being used to characterize the communication infrastructure and the processors of the architecture. This control stage may also validate the functional characteristics of each instance of the second instruction generation stage, that is to say, of each phase in generating a test sequence for a processor. In other words, it allows the activation of a functional characteristic relating notably to the processor type (VLIW, SIMD, Multi-thread, etc.) or any combination of these characteristics.

This first control stage may also configure the communication architecture between the processors by assigning each processor a processor identifier and by determining the number of communication channels between the processors.

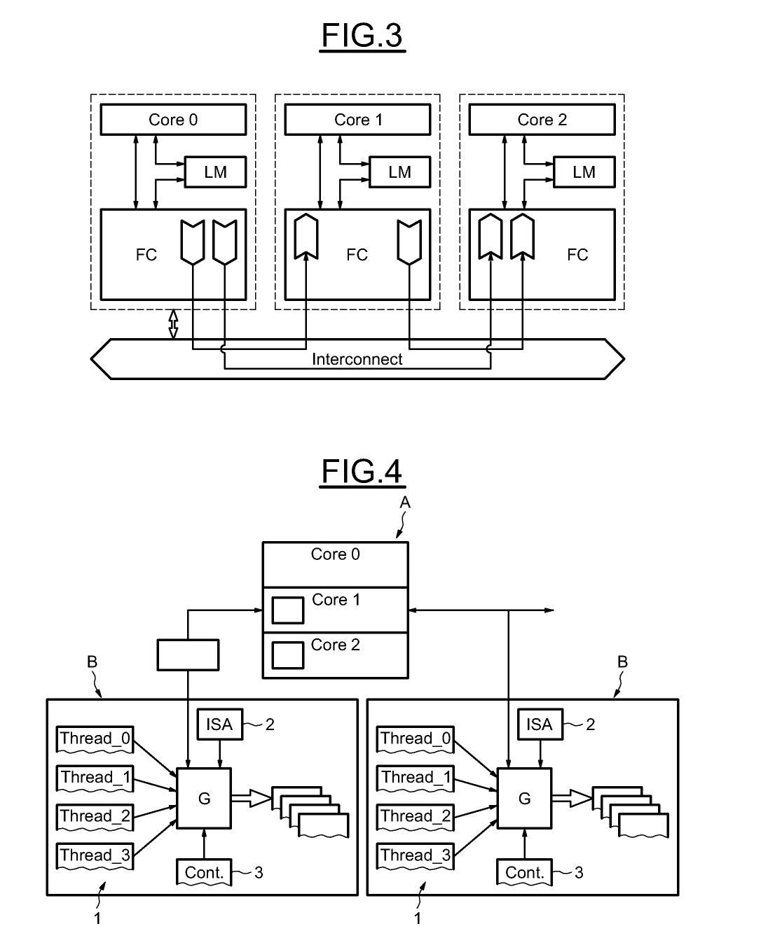

Thus, referring to FIG. 2, during a first step 10, the first control stage proceeds to select a processor. During the next step 12, it invokes the generation of a test sequence from the sequence generators 1a, . . . 1d stored in memory, based on constraints 3 and on the communication architecture data 2.

It will be noted that each processor may be either a receiver or a sender. Thus, in addition to the configuration parameters, the data originating from the communication channels is also collected. This instruction sequence generation step is launched when all the data relating to the communication infrastructure, including the data originating from the various processors, has been collected and transmitted to the second generating stage B in order for the test sequences to be generated for the selected processor (step 13).

It will be noted that, in the case where the first selected processor is a receiver, inasmuch as the processors are selected sequentially, the first control stage A does not have any information concerning the data transmitted to this first processor. Consequently, inasmuch as the processor sending data towards this first receiving processor has not yet sent its data, this data is simulated by being generated randomly by a data generator incorporated in the first control stage A and transmitted to the second generating stage B. Furthermore, during this simulation phase, additional data may be generated and transmitted towards other processors.

For example, in the case where a first processor and a second processor are connected by a communication channel and are both transmitters or receivers, assuming the case where the first processor receives data from the second processor, which has not yet generated the data intended to be transmitted to the first processor, the first control stage of the test architecture randomly generates this data in order to simulate the communication between the two processors. This data is consumed during the test sequence generation procedure by the second generating stage B.

New communication data sent to the second processor may also be generated in the same way.

Thus, the first control stage has, on the one hand, data that the second processor creates and, on the other hand, data that the first processor consumes so that the test sequences generated by the second stage for each of the processors are generated by taking account of this data.

All this generated data is collected (step 14) to be transferred to the other processors.

It will be noted that the steps 10, 12, 13 and 14 mentioned previously are performed for each of the processors so that, during the next step 15, if the selected processor is not the last, during the next step 16, the data generated randomly is collected and used by the first control stage to be sent to other processors.

It will be noted that, during the procedure for testing a multitasking computation architecture using the system that has just been described, configuration information for the multitasking computation architecture and data originating from other processors are collected or, where appropriate, generated randomly, then sent to the second instruction generation stage B in order to launch the generation of the test sequences. This tool is thus capable of consuming data originating from other processors or generated randomly by taking account of the configuration of the communication architecture.

When the generation of the test sequences is completed, the test sequences are available to be launched within a processor corresponding to the identifier associated with the test sequence and with the processor. The data generated randomly that relates to the communication architecture is collected and transmitted to the first control stage A to be sent to other processors.

It will be noted that an unlimited number of communication channels may be configured in order to be adaptable to any type of communication architecture. Similarly, there may be any number of processors, so that the method and the system that have just been described may be adapted to any type of multitasking computation architecture.

It will also be noted that the data originating from the communication channels has a high priority level. It is consumed as a priority during the generation of the tests.

There now follows a description, with reference to FIGS. 3, 4 and 5, of an exemplary implementation of a test procedure generated as described previously.

In the example illustrated in FIG. 3, the architecture comprises three processors designated by the references “CORE 0,” “CORE 1” and “CORE 2.” Each processor is associated with a local memory LM and a flow controller FC. An interconnection network “Interconnect” handles the communication of the data between the processors.

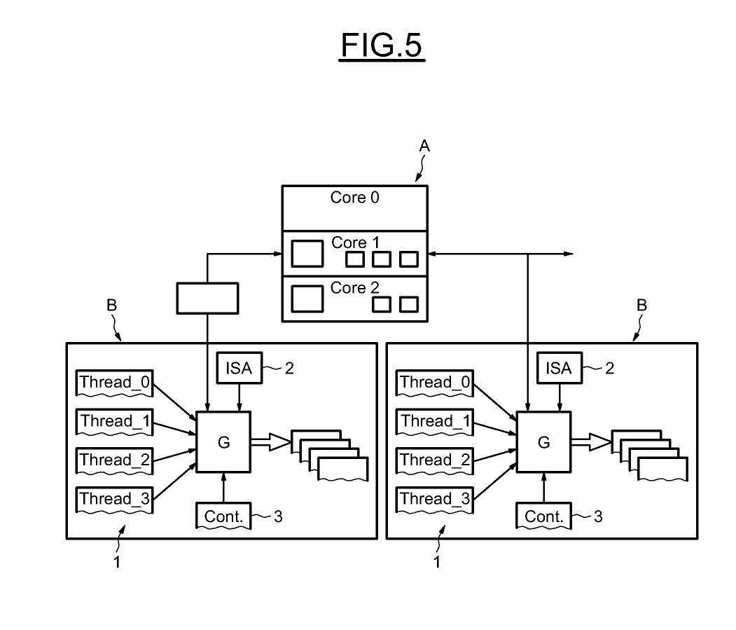

During a first phase, the first processor “CORE 0” is selected. For example, this first processor is a receiver so that configuration information is transmitted, namely characteristics relating to the processors and communication configuration data generated randomly. This data is transmitted to the second generating stage B to be consumed and for the generation of a test sequence for the first processor (FIG. 4). When the test sequence is completed, all the data generated is transferred to the other processors and also collected by the first control stage (FIG. 5).

In the exemplary implementation illustrated, the test implemented within the first processor has generated three data items intended for the first processor and two data items intended for the second processor. These data items, which are stored within the first control stage A, are used to implement the second phase of the second generating stage B intended for the generation of the test sequences for the second processor. The procedure then continues the generation of the test sequences for the other processors.

While this detailed description has set forth some embodiments of the present invention, the appended claims cover other embodiments of the present invention which differ from the described embodiments according to various modifications and improvements.

Within the appended claims, unless the specific term “means for” or “step for” is used within a given claim, it is not intended that the claim be interpreted under 35 U.S.C. 112, paragraph 6.

What is claimed is:

1. A system comprising:
a generating stage that provides sequences of test instructions based on characteristics of a plurality of processors, the characteristics comprising programming rules for the plurality of processors, each of the plurality of processors being linked by at least one data communication channel; and
a control stage coupled to the generating stage, the control stage providing to the generating stage data representative of the at least one data communication channel.

2. The system according to claim 1, wherein the control stage is invoked once and the generating stage is invoked once for each of the plurality of processors.

3. The system according to claim 1, further comprising a data generator in the at least one data communication channel.

4. The system according to claim 1, wherein the generating stage uses a description of or programming instructions for the multitasking computation architecture, the description of or programming instructions for the multitasking computation architecture being stored in a memory.

5. The system according to claim 1, wherein the generating stage uses a description of the multitasking computation architecture to be tested, the description of the multitasking computation architecture being stored in a memory.

6. A method comprising:
generating sequences of test instructions based on characteristics of a plurality of processors, each of the plurality of processors being linked by at least one data communication channels, the characteristics comprising programming rules for the plurality of processors, the sequences of test instructions being generated from data representative of the communication channels.

7. The method according to claim 6, wherein the data representative of the communication channels is collected from data circulating between the plurality of processors.

8. The method according to claim 7, in which, for a test of a first receiving processor, the data circulating towards said plurality of processors is generated randomly.

9. The method according to claim 6, wherein an identifier is assigned to each of the plurality of processors and wherein the plurality of processors are tested sequentially based on the identifiers assigned to the plurality of processors.

10. The method according to claim 6, wherein the sequences of test instructions are generated automatically from operation codes and operands selected from test constraints generated randomly or specified by a user.

11. A computer program product for testing a multitasking computation architecture, the computer program product having a computer-readable, non-transitory medium with a computer program embodied thereon, the computer program comprising:
computer program code for generating test programs, at least one test program being generated for each of a plurality of processors, the plurality of processors having one or more data communication channels interconnecting different ones of the plurality of processors; and
computer program code for controlling the generating test programs and to control the testing of the plurality of processors.

12. The computer program product according to claim 11, wherein the computer program code for generating test programs is performed at least in part by using architecture data.

13. The computer program product according to claim 12, wherein the architecture data includes parameters descriptive of program instructions for the multitasking computation architecture.

14. The computer program product according to claim 11, wherein the computer program code for generating test programs is performed at least in part by retrieving one or more constraints from memory.

15. The computer program product according to claim 11, wherein the computer program code for generating test programs is performed at least in part by using a plurality of test sequences.

16. The computer program product according to claim 15, where the plurality of test sequences are generated randomly.

17. The computer program product according to claim 11, wherein the computer program code for controlling uses as input a configuration file, the configuration file characterizing a communication infrastructure and the plurality of processors.

18. The computer program product according to claim 11, wherein the computer program code for generating test programs is instantiated once for each of the plurality of processors and the computer program code for controlling is instantiated once.

19. The computer program product according to claim 11, wherein the computer program code for controlling comprises computer program code for collecting data from a communication channel of a first processor.

20. The computer program product according to claim 19, wherein the collected data from the communication channel of the first processor is provided to a second processor as input.

21. The computer program product according to claim 11, wherein input to a first processor from a communication channel is generated randomly by a data generator.

22. The computer program product according to claim 11, wherein the computer program code for generating test programs is performed at least in part by using data produced by one or more of the plurality of processors as output.

23. The computer program product according to claim 11, wherein the computer program code for controlling comprises computer program code for receiving output from a first processor as a result of the computer program code for generating test programs for the first processor, and computer program code for providing the output as input to the computer program code for generating test programs for a second processor.
